(19) United States
(12) Patent Application Publication
(10) Pub. No.: US 2020/0279433 A1
(43) Pub. Date: Sep. 3, 2020

(54) METHODS AND APPARATUS FOR GPU TILE CLEARANCE

(71) Applicant: QUALCOMM Incorporated, San Diego, CA (US)

(72) Inventors: Kevin MATLAGE, Erie, CO (US); Piyush AGARWAL, San Diego, CA (US); Jonathan WICKS, Louisville, CO (US)

(21) Appl. No.: 16/289,449

(22) Filed: Feb. 28, 2019

(51) Int. Cl. G06T 15/40; G06T 15/00; G06T 1/20; G06T 1/60

(52) U.S. Cl. CPC G06T 15/40; G06T 1/60; G06T 1/20; G06T 15/005

(57) ABSTRACT

The present disclosure relates to methods and apparatus of operation of a graphics processing unit (GPU). The apparatus can write, for each tile in a set of tiles in a tile memory, clear color information to a buffer corresponding to the tile. Additionally, the apparatus can render at least one tile in the set of tiles to a system memory. In some aspects, the at least one tile can include additional information other than the clear color information. The apparatus can also write, for the at least one tile that includes the additional information, information associated with the additional information to the buffer corresponding to the tile. Further, the apparatus can generate, for each tile in the set of tiles, visibility information for the tile. In some aspects, the visibility information can include information regarding whether the tile includes visible draw calls.

### TECHNICAL FIELD

The present disclosure relates generally to processing systems and, more particularly, to one or more techniques for graphics processing.

### INTRODUCTION

Computing devices often utilize a graphics processing unit (GPU) to accelerate the rendering of graphical data for display. Such computing devices may include, for example, computer workstations, mobile phones such as so-called smartphones, embedded systems, personal computers, tablet computers, and video game consoles. GPUs execute a graphics processing pipeline that includes one or more processing stages that operate together to execute graphics processing commands and output a frame. A central processing unit (CPU) may control the operation of the GPU by issuing one or more graphics processing commands to the GPU. Modern day CPUs are typically capable of concurrently executing multiple applications, each of which may need to utilize the GPU during execution. A device that provides content for visual presentation on a display generally includes a GPU.

Typically, a GPU of a device is configured to perform the processes in a graphics processing pipeline. However, with the advent of wireless communication and the streaming of content, e.g., graphical content or any other content that is rendered using a GPU, there has developed a need for improved graphics processing.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processing unit (GPU). The apparatus can write, for each tile in a set of tiles in a tile memory, clear color information to a buffer corresponding to the tile. Also, the apparatus can render at least one tile in the set of tiles to a system memory. In some aspects, the at least one tile can include additional information other than the clear color information. The apparatus can also write, for the at least one tile that includes the additional information, information associated with the additional information to the buffer corresponding to the tile. In some instances, rendering the at least one tile to the system memory can further comprise skipping tiles in the set of tiles that include only clear color information. Further, the apparatus can generate, for each tile in the set of tiles, visibility information for the tile. In some aspects, the visibility information can include information regarding whether the tile includes visible draw calls.

In another aspect of the disclosure, a method, a computer-readable medium, and an apparatus are provided. The apparatus may be a graphics processing unit (GPU). The apparatus can render at least one tile in a set of tiles in a tile memory to a system memory. In some aspects, the at least one tile can include additional information other than clear color information. The apparatus can also write, for each tile in the set of tiles, clear color information to a buffer corresponding to the tile. Also, the apparatus can write, for the at least one tile that includes the additional information, information associated with the additional information to the buffer corresponding to the tile. In some aspects, rendering the at least one tile to the system memory can include skipping tiles in the set of tiles that include only clear color information. Moreover, the apparatus can generate, for each tile in the set of tiles, visibility information for the tile. In some aspects, the visibility information can include information regarding whether the tile includes visible draw calls.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example system memory in accordance with one or more techniques of this disclosure.

FIG. 3 illustrates an example system memory in accordance with one or more techniques of this disclosure.

FIG. 4 illustrates an example flowchart of an example method in accordance with one or more techniques of this disclosure.

FIG. 5 illustrates an example flowchart of an example method in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

As used herein, instances of the term “content” may refer to graphical content or display content. In some examples, as used herein, the term “graphical content” may refer to a content generated by a processing unit configured to perform graphics processing. For example, the term “graphical content” may refer to content generated by one or more processes of a graphics processing pipeline. In some examples, as used herein, the term “graphical content” may refer to content generated by a graphics processing unit. In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer, which may also be referred to as a framebuffer. A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

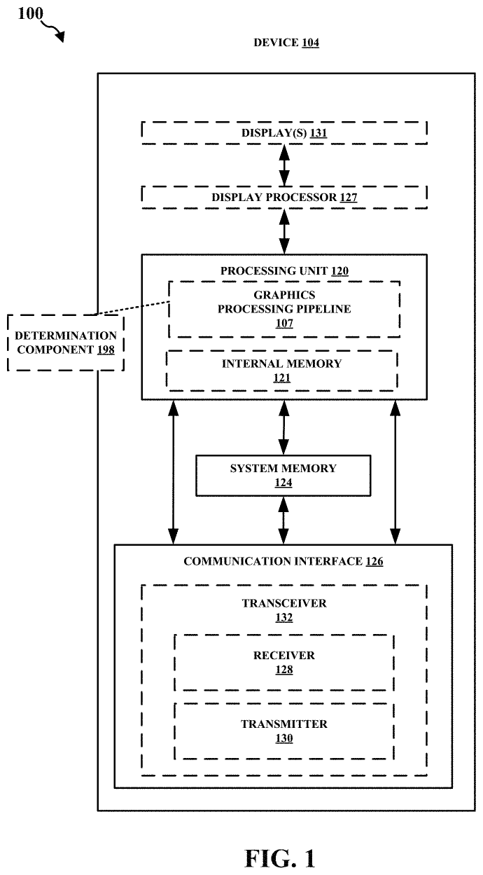

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, and a system memory 124. In some aspects, the device 104 can include a number of optional components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon.

The processing unit 120 may include an internal memory 121. The processing unit 120 may be configured to perform graphics processing, such as in a graphics processing pipeline 107. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120, such as system memory 124, may be accessible to the processing unit 120. For example, the processing unit 120 may be configured to read from and/or write to external memory, such as the system memory 124. The processing unit 120 may be communicatively coupled to the system memory 124 over a bus. In some examples, the processing unit 120 may be communicatively coupled to each other over the bus or a different connection.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The communication interface 126 may include a receiver 128 and a transmitter 130.

The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the graphics processing pipeline 107 may include a determination component 198 configured to write, for each tile in a set of tiles in a tile memory, clear color information to a buffer corresponding to the tile. Also, the determination component 198 can be configured to render at least one tile in the set of tiles to a system memory. In some aspects, the at least one tile can include additional information other than the clear color information. The determination component 198 can also be configured to write, for the at least one tile that includes the additional information, information associated with the additional information to the buffer corresponding to the tile. In some instances, to render the at least one tile to the system memory can include the determination component 198 further configured to skip tiles in the set of tiles that include only clear color information. Further, the determination component 198 can be configured to generate, for each tile in the set of tiles, visibility information for the tile. In some aspects, the visibility information can include information regarding whether the tile includes visible draw calls.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, an augmented reality device, a virtual reality device, a display or display device, a television, a television set-top box, an intermediate network device, a digital media player, a video streaming device, a content streaming device, an in-car computer, any mobile device, any device configured to generate graphical content, or any device configured to perform one or more techniques described herein.

GPUs can render images in a variety of different ways. In some instances, GPUs can render an image using tiled rendering. As used herein, “tiled rendering GPUs” can refer to GPUs that can render an image at least using tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. By doing so, tiled rendering GPUs can potentially reduce the amount of memory or data required to render an entire image. In some aspects, during a binning pass, an image can be divided into different tiles or bins. Moreover, in the binning pass, different pixels can be shaded in certain tiles, e.g., using draw calls.

In some instances of tiled rendering GPUs, the geometry of a tile may be converted into screen space, e.g., where the screen space may be assigned to certain tiles. In order to do so, a tiled rendering GPU can store the geometry data for each of the tiles. This geometry data storage process can be performed by a CPU or certain hardware on the GPU. In some aspects, the GPU can reduce the amount of pixels that are processed, by, for example, limiting the processing of certain pixels that may not be visible. Additionally, by limiting the amount of pixels that are processed, tiled rendering GPUs can reduce the corresponding memory or processing bandwidth.

Aspects of the present disclosure can refer to a number of different terms or phrases regarding tiled rendering GPUs, e.g., tiles, bins, or blocks. In some aspects, a bin can refer to a tile or a group of tiles. For example, in some instances, a bin can be any number of different pixel dimensions, e.g., 256 by 256 pixels. In some instances, a block can refer to a smaller pixel dimension compared to a bin, e.g., 16 by 4 pixels. Further, blocks can operate as an entire unit. For some blocks, the present disclosure can perform a compression, e.g., by compressing the blocks and then writing them as a single unit during the rendering process. By doing so, the present disclosure can have lossless compression on certain blocks.

In some aspects, the present disclosure can apply the drawing or rendering process to different bins or tiles. For instance, the present disclosure can render to one bin, and then perform all the draws for the pixels in the bin. Additionally, the present disclosure can render to another bin, and perform the draws for the pixels in that bin. Therefore, in some aspects, there might be a small number of bins, e.g., four bins, that cover all of the draws in one surface. Further, the present disclosure can cycle through all of the draws in one bin, but only perform the draws for the pixels that are relevant, i.e., pixels that include visible geometry, in that bin. In some instances, the present disclosure can perform memory clears on a block level or a bin or tile level. Moreover, individual compression blocks can be organized in a number of different ways, e.g., by how they store and/or save data. As such, blocks can be used for compression and/or providing improved memory performance. Also, in some aspects, a bin can include a number of individual tiles.

In some aspects of tiled rendering GPUs, the tiled memory can be cleared and stored for each tile. For instance, the performance, bandwidth, and/or power of the GPU can be used to clear or store the memory of certain tiles, e.g., tiles that have no visible draw calls. In some instances, certain information, e.g., clear color information, can be cleared and stored to the system memory. In some aspects, clear color information can refer to information that identifies a certain tile is to be cleared of its current color. However, these types of tiled memory clearances can require time or bandwidth. Accordingly, there is a need to reduce the amount of time and/or bandwidth required to clear or store the system memory.

The present disclosure can also be used with a number of different memory or tile sizes. For example, a full surface of tiles, i.e., the amount of data in an image, can include a large number of bytes, e.g., eight megabytes. In contrast, buffers or compressed buffers mentioned herein may store a significantly lower number of bytes, e.g., ten kilobytes. Accordingly, buffers or compressed buffers herein can be small compared to the data in an image. As such, a memory or data clearance to a buffer or compressed buffer can potentially result in a large magnitude reduction of memory or data cleared, especially compared to a full clearance of a surface of tiles. In some aspects, buffers or compressed buffers described herein can be referred to as flag buffers. Additionally, the tile size of the present disclosure can be determined, e.g., on the CPU, when a given surface begins processing. In some aspects, there can be an algorithm that determines how to break up the image into tiles in an efficient manner. For example, when the present disclosure processes the commands to render to a surface, the present disclosure can determine the image-to-tile breakdown based on the different color formats and/or the size of the surface.

The present disclosure can reduce the amount of time required to clear the system memory and/or reduce the processing, bus, and/or memory bandwidth required to clear the system memory in tiled rendering GPUs. During a binning pass, a visibility stream can be constructed where draw calls can shade pixels in certain tiles. In some aspects, a visibility stream can refer to shading visible pixels in tiles. As mentioned previously, an image can also be divided into tiles or bins during the binning pass. Using the visibility information, the present disclosure can determine if a given tile is rendered by any of the draw calls. Further, the present disclosure can determine if a tile is only affected by a surface clear, e.g., a clear of all the data in an image. This information can be used to determine which draw calls can be processed in which tiles. Additionally, the information can be used to determine if a given tile is rendered by any of the draw calls.

In some aspects, the present disclosure can save clear color information for certain tiles to a buffer or compressed buffer. In some instances, when the clear color information is saved to memory, e.g., to the buffer or compressed buffer, the present disclosure may optimize the manner in which the memory is cleared. For example, the present disclosure can perform the memory clearance to the buffer, rather than clear an entire surface of tiles. As mentioned herein, the buffers or compressed buffers mentioned herein can store a significantly lower amount of data compared to a full surface of tiles. Accordingly, a memory or data clearance to a buffer or compressed buffer can result in a large magnitude reduction of memory or data cleared. By doing so, the a memory clearances to a buffer described herein can be an efficient way to handle a memory clearance compared to other methods of tiled memory clearances. Additionally, the processing or clearance of entire tile sets may be skipped when the aforementioned buffer memory clearances are utilized.

In some aspects, the present disclosure can take data generated in a geometry or binning pass, e.g., a pass determining whether certain tiles have visible geometry, and utilize that data in a new and improved manner. For example, the present disclosure can include a compressed clear directly to the system memory, e.g., through the use of a buffer, rather than clearing to a GPU memory first. In some aspects, the clear can be written to the system memory, e.g., in a compressed format. In some instances, by combining data with the aforementioned compressed clear to the system memory, the present disclosure can reduce some aspects of the tile rendering process.

As mentioned herein, buffers herein can be compressed buffers, which can include data or compressed data. Further, buffers herein can include a header or metadata section describing the compressed data. By including the header or metadata section that describes the compressed data, the present disclosure can determine how to decompress the data. As discussed herein, the present disclosure can perform a fast, compressed system clear to a buffer or metadata section of a buffer. By doing so, rather than clearing large data sections at one time, the present disclosure can clear memory by using a smaller, compressed buffer section. These compressed buffer sections of the present disclosure can describe or represent a larger data section, but may not require the same amount of memory or data to make a clearance. Accordingly, the present disclosure can provide for a compressed system clear that does not require the bandwidth of an entire tile data clearance.

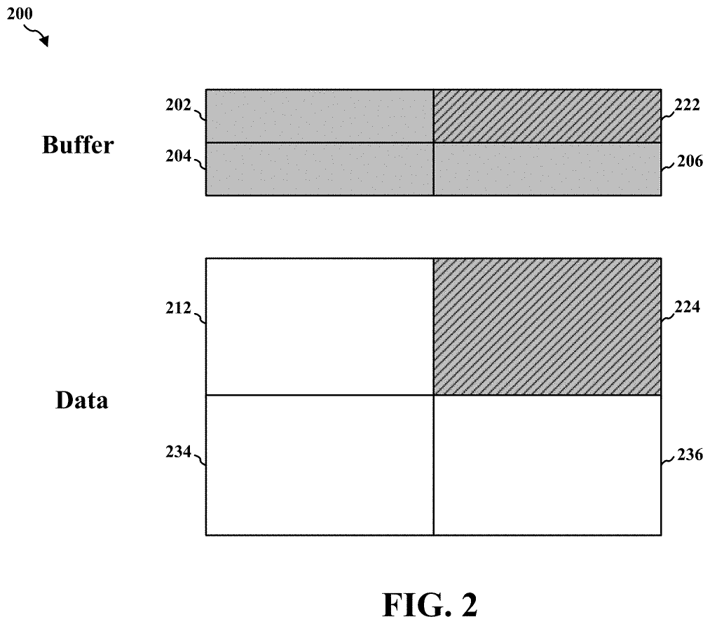

FIG. 2 illustrates an example system memory 200 in accordance with one or more techniques of this disclosure. As shown in FIG. 2, system memory 200 includes buffer sections 202, 204, 206, and 222 and tiles 212, 224, 234, and 236. In system memory 200, buffer section 202 corresponds to tile 212, buffer section 204 corresponds to tile 234, buffer section 206 corresponds to tile 236, and buffer section 222 corresponds to tile 224. FIG. 2 shows that buffer sections 202, 204, and 206 are gray colored, while buffer section 222 is gray with black stripes. The gray color in buffer sections 202, 204, and 206 represents that clear color information has been written to these buffer sections. The gray with black stripes in buffer section 222 represents that additional information other than the clear color information has been written to the buffer section.

Regarding the tiles in FIG. 2, tiles 212, 234, and 236 are white or clear, and tile 224 is gray with black stripes. The gray with black stripes in tile 224 represents that the tile includes additional information other than the clear color information. In some aspects, the additional information can be visibility information or shading information. Also, tile 224 has been rendered to the system memory 200. The white or clear color in tiles 212, 234, and 236 represents that these tiles do not include additional information other than the clear color information. As such, tiles 212, 234, and 236 can be referred to as clear-only tiles. Moreover, tiles 212, 234, and 236 may not have been rendered to the system memory 200. Accordingly, during the rendering process or a render pass, tiles 212, 234, and 236 may be skipped.

In system memory 200, an initial step of operation can be writing the clear color information to buffer sections 202, 204, and 206. In some aspects, clear color information can be written to buffer section 222 at the same time. Next, tile 212 can be skipped, i.e., not rendered, as the clear color is the final value for the tile. Also, tile 224 can be rendered to the system memory 200, as the tile 224 may include additional information other than the clear color information. As tile 224 is being rendered, the clear color may not be the final value for the tile. The additional information other than the clear color information in tile 224 can then be written to the buffer section 222. Further, tiles 234 and 236 can be skipped, i.e., not rendered, as the clear color is the final value for these tiles. As such, the order of the reference numbers of the tiles and buffer sections in FIG. 2 can somewhat correspond to the processing order for that tile or buffer section.

As shown in FIG. 2, when the present disclosure performs a compressed clear to the system memory 200, certain tiles or bins can be skipped or not rendered when the clear color is the final value for that tile or bin. For other tiles or bins that do not include the clear color as their final value, e.g., tile 224, the present disclosure can render an image from the GPU memory and save it to the tile or bin. For tiles or bins that can be skipped, e.g., tiles 212, 234, 236, the present disclosure already has the final image for that tile, so the buffer does not need to be updated further beyond the clear color information. In some instances, this can be a way to skip updating certain sections of the frame, e.g., as these sections may already contain their final value or clear color. For instance, only tiles with visible draws may be rendered. By doing so, a GPU can reduce the amount of time needed and/or the bandwidth required to clear the system memory. The other tiles can be skipped, as they have already been cleared to their respective clear color. Indeed, tiles that are skipped, e.g., tiles 212, 234, 236, may have already been cleared or been marked that they do not require clearing.

In some aspects, the present disclosure may not determine what type of data is in certain tiles. For example, a certain tile may be cleared to be a certain color, e.g., black or white, and the present disclosure can mark this clearance with a few bits, e.g., one or two bits, in the header or meta data section of the buffer. Further, the present disclosure can use the tile color that is specified in the clear color data. In FIG. 2, this occurs in buffer sections 202, 204, 206. Additionally, the present disclosure can interpret these buffer sections as a clear compression format. As such, the present disclosure can avoid performing a clear by marking a few bits in the header or meta data section of a buffer, so that most of the data for the tile is not updated. For instance, the present disclosure may only mark that certain tiles, e.g., tiles 212, 234, 236, were cleared to a certain color. As mentioned previously, this can provide a number of advantages to the GPU, e.g., reduction in time, bandwidth, or cost required for operation.

In some aspects, the present disclosure can include a binning pass that processes the geometry for each tile. One or more bits or information obtained from this binning pass can inform the GPU if there is any visible geometry in a given tile or bin. When this is implemented, the present disclosure can have a conditional execution of the commands from these bits. In some instances, GPUs according to the present disclosure can perform an initial clear and mark this clear in the buffer. When the present disclosure processes each tile or bin, it can determine whether a clear was performed and whether there is rendering to be performed for the tile or bin. In some aspects, the present disclosure can mark this information on the GPU in a command stream in a register. Additionally, the present disclosure can reference the buffer to determine this information. As mentioned herein, if a tile is assigned clear-only status, it can be skipped or not rendered. In some instances, tiles that may be rendered, e.g., draw call status tiles, can also be cleared on the same pass as clear-only tiles. For instance, the present disclosure can clear the clear color information for a certain pass from the buffer, or perform the clear on the entire system memory.

As mentioned herein, the present disclosure can perform a binning pass to sort the geometry of each tile and/or determine what geometry is visible in each tile or bin. In some instances, this binning pass can be a pre-geometry processing pass that is performed prior to the actual rendering of pixels. GPUs according to the present disclosure can utilize the information from the binning pass to determine which tiles to render. Additionally, during the binning pass, there can be a register to mark if there are any visible draws in a tile or bin. In some instances, this pass may not include a clear, but it can include a draw other than a clear, e.g., a draw for a particular bin. During some memory clearances, the GPU can clear the tiles or bins at the same time. In these clears, when the GPU processes a certain tile or bin, it can clear the tile memory and save it to the system memory. As mentioned above, the tiled memory can be cleared and saved to the system memory by utilizing the header or meta data section of the buffer. By doing so, the present disclosure can quickly determine if a given bin or tile has been cleared, as well as whether it should be rendered or skipped.

As mentioned herein, during an initial pass of the compressed clear, the present disclosure can clear tiles or bins marked with only the clear color information, i.e., including a clear-only label. In a follow-up pass, the present disclosure can skip these tiles or bins, e.g., tiles 212, 234, 236, as there is no rendering to be performed for these tiles. Moreover, as mentioned previously, in the geometry or binning pass, the present disclosure can mark which tiles have visible geometry. In some aspects, the clear-only tiles may not actually be marked after the initial pass, but the present disclosure can understand that they have been cleared. For instance, the clear-only tiles may include an indication that they were cleared in another register or section of the tiled rendering GPU.

During an initial pass, the present disclosure can perform a fast, compressed clear to clear the tile memory from the GPU. For example, GPUs herein can write to a section of system memory 200, e.g., the buffer or compressed buffer shown in FIG. 2. In some aspects, the clearance information can be stored in a register state on the GPU. For example, there can be a register on the GPU that can store and inform the GPU once an initial clear has been performed. By doing so, the present disclosure can determine which bins or tiles have been cleared and include the clear color.

In other aspects, the present disclosure may not use a register to store clearance information. In these instances, in order to determine or keep track of which tiles have been cleared, the present disclosure can utilize data packets that are stored on the GPU. For example, data packets can store information regarding memory clearances, such as when certain bins or tiles have been cleared and should be skipped during the rendering process. The data packets can be similar to the aforementioned register, such that the data packets are stored on the GPU. However, there may be a number of separate data packets, rather than a single register. In some aspects, if the present disclosure does not perform a clear, it may not utilize these data packets. In further aspects, the present disclosure might perform the compressed clear on a CPU, e.g., if there is no dedicated register on the GPU to perform the clear. In some instances, the present disclosure may have one bit that stores the data regarding which tiles have been cleared to the clear color. The present disclosure can also determine the specific type of clear color, e.g., white or black. GPUs according to the present disclosure can also utilize other indicators or bits regarding tile information, e.g., bits that inform the GPU whether a tile or bin has any visible geometry.

As shown in FIG. 2, system memory 200 can perform a full surface clear of all tiles using a compressed clear to the buffer. As mentioned above, in some aspects, only tiles with visible draws may be rendered to the tiled memory and/or resolved to the system memory. The memory clearance approach utilized in system memory 200 can be performed in a number of different operations. For example, the present disclosure can perform a first pass through the tiles, e.g., tiles 212, 224, 234, 236, for memory clearance. Then, the present disclosure can write to the buffer, e.g., via buffer sections 202, 222, 204, 206, based on the tiles 212, 224, 234, 236 that were cleared in the first pass. After this, the present disclosure can make a second pass through the tiles 212, 224, 234, 236 by skipping clear-only tiles, e.g., tiles 212, 234, 236, that were cleared in first pass. Then, the present disclosure can render the tiles that include information other than clear color information, e.g., tile 224. Moreover, the present disclosure can write to the buffer based on the rendered tiles.

Referring again to FIG. 2, in some aspects, the present disclosure can utilize a software focused approach to clear the system memory 200. For instance, system memory 200 can use visibility stream information, e.g., from a geometry pass, in order to perform a fast, compressed clear of the system memory. This visibility information from the geometry pass can be associated with the visibility of tiles in a surface. In some instances, the geometry pass can be performed after a binning pass and before a render pass, which can determine if any of the bins are clear-only, i.e., not touched by draw calls. For instance, this software focused approach can use visibility stream information in order to determine if any tiles can be completely skipped, e.g., the tiles were not rendered in any draw calls.

In some instances, the aforementioned software based approach can be part of a fast, compressed clear of the system memory associated with a surface after a binning pass and before a render pass. This fast, compressed clear can be conditionally executed by the GPU based on the visibility stream data from the binning pass. For instance, if any of the tiles are clear-only tiles, i.e., where no rendering is required, then the present disclosure may execute the full surface clear directly to the system memory, e.g., after the binning pass. In these instances, during a render pass, each tile can be conditionally executed based on the bits associated with the tile in the visibility stream. Further, for tiles with visible geometry, i.e., there are scheduled draw calls or rendering for the tile, the tile clear can be executed normally. This can include a tiled memory clearance to a buffer, so that the system memory clear data may not be loaded into GPU memory. In other aspects, the present disclosure can load the clear color information from the system memory to the GPU.

As mentioned above, during the software based approach, clear-only tiles that do not include any visible geometry may be skipped or not rendered. In some aspects, this approach can allow draw calls to be skipped for clear-only tiles, i.e., tiles that can use the clear color and do not need to be rendered. Additionally, this approach can allow for skipping the memory clearance for the tile, as well as skipping any storage of the GPU memory for the tile to the system memory. By doing so, this can reduce the amount of work performed for the tile memory clearance. For example, there may be no clears or draws executed for clear-only tiles, and there may be no system memory storage performed for these tiles. As mentioned herein, the clear value for a clear-only tile may already be present in the system memory due to the fast, compressed clear that was executed, e.g., between the binning pass and the render pass. As such, the clear color value can represent the final value that should be present for the tile or bin.

As shown in FIG. 2, the present disclosure can generate, for each of the tiles 212, 224, 234, 236 in a set of tiles in a tile memory, visibility information for the tile. This visibility information can include information regarding whether the tile includes visible draw calls or rendering, and can be generated for each tile in a binning pass. The present disclosure can also write, for each tile 212, 224, 234, 236, clear color information to a buffer section 202, 222, 204, 206 corresponding to the tile. Additionally, the present disclosure can render at least one tile, e.g., tile 224, to a system memory. The at least one tile, e.g., tile 224, can include additional information other than the clear color information. Also, when rendering tile 224 to the system memory, the present disclosure can further skip certain tiles, e.g., tiles 212, 234, 236, that include only clear color information. Moreover, the present disclosure can write, for the at least one tile that includes the additional information, e.g., tile 224, information associated with the additional information to the buffer corresponding to the tile, e.g., buffer section 222. In some aspects, the additional information can be based on the visibility information. In addition, the system memory can include compressed data corresponding to each tile in the tile memory, e.g., tiles 212, 224, 234, 236. The buffer can also include information associated with the compressed data, e.g., buffer sections 202, 222, 204, 206, that correspond to each tile, e.g., tiles 212, 224, 234, 236.

In some aspects, as shown in FIG. 2, the present disclosure can write the clear color information to a buffer for all of the tiles at the same time. Subsequently, the present disclosure can write to the buffer the information that is currently being drawn or rendered at certain tiles. In other approaches mentioned herein, the present disclosure may only write and/or render to a buffer section corresponding to each tile in a single step.

By performing the aforementioned compressed clear utilizing a buffer, the present disclosure can save the additional work required to clear the tile memory for the clear-only tiles, i.e., tiles that will use the clear color and are skipped during the rendering process. Accordingly, by using the header or meta data section of a buffer and/or skipping tiles that do not need to be rendered, the present disclosure can perform a fast, compressed clear of the system memory. The present disclosure can avoid performing a clear of the larger tile memory, e.g., by instead performing a smaller clear using compressed data, metadata, and/or a buffer.

As mentioned previously, aspects of the present disclosure can reduce overhead when performing tiled memory clearances. As such, the present disclosure can increase the efficiency of memory clearances. For instance, by maintaining a few bits to determine if a certain tile or bin has been cleared, e.g., in a header or metadata section of a buffer, the present disclosure can reduce the overhead during the clearance. By doing so, the present disclosure may reduce the amount of power, time, bandwidth, and performance utilized for graphics processing.

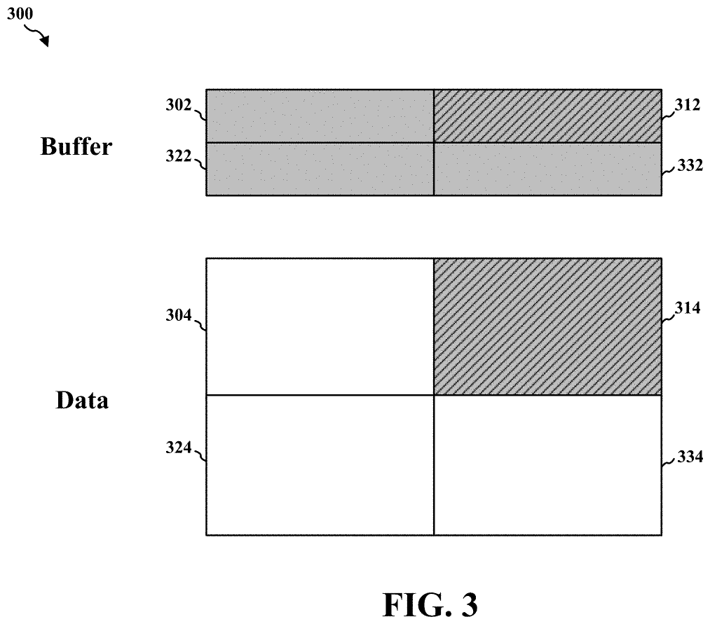

FIG. 3 illustrates an example system memory 300 in accordance with one or more techniques of this disclosure. As shown in FIG. 3, system memory 300 includes buffer sections 302, 312, 322, 332 and tiles 304, 314, 324, 334. In system memory 300, buffer section 302 corresponds to tile 304, buffer section 312 corresponds to tile 314, buffer section 322 corresponds to tile 324, and buffer section 332 corresponds to tile 334. FIG. 3 shows that buffer sections 302, 322, and 332 are gray colored, while buffer section 312 is gray with black stripes. The gray color in buffer sections 302, 322, and 332 represents that clear color information has been written to these buffer sections. The gray with black stripes in buffer section 312 represents that additional information other than the clear color information has been written to the buffer section.

Regarding the tiles in FIG. 3, tiles 304, 324, and 334 are white or clear, and tile 314 is gray with black stripes. The gray with black stripes in tile 314 represents that the tile includes additional information other than the clear color information. Also, tile 334 may have been rendered to the system memory 300. The white or clear color in tiles 304, 324, and 334 represents that these tiles may not include additional information other than the clear color information. Further, tiles 304, 324, and 334 may not have been rendered to the system memory 300. As such, during the rendering process or render pass, tiles 304, 324, and 334 may be skipped.

In system memory 300, an initial operation step can be writing the clear color information to buffer section 302. Next, tile 304 can be skipped, i.e., not rendered, as the clear color is the final value for the tile. Tile 314 can then be rendered to the system memory 300, as the tile 314 may include additional information other than the clear color information. Because tile 314 is being rendered, the clear color may not be the final value for the tile. The additional information other than the clear color information in tile 314 can then be written to the buffer section 312. In some aspects, the clear color information can also be written to the buffer section 312. Next, the clear color information can be written to buffer section 322. Tile 324 can be skipped, i.e., not rendered, as the clear color is the final value for this tile. The clear color information can then be written to buffer section 332. Further, tile 334 can be skipped, i.e., not rendered, as the clear color is the final value for the tile. Therefore, the order of the reference numbers of the tiles and buffer sections in FIG. 3 can somewhat correspond to the processing order for that tile or buffer section.

The memory clearance used in system memory 300 can be a hardware focused approach. In this approach, the hardware in the GPU can handle the clearance by itself, i.e., with little or no software input. In some aspects, this can be more efficient for the GPU and/or require some minor optimizations. In some instances, the GPU hardware can self-detect, e.g., using a visibility stream, which tiles may have no draw calls. As mentioned above, this can be accomplished without software input. This self-detection in the hardware can also allow for reduced microcode generation and processing, as well as move the conditional execution closer to the hardware for fewer pipeline bubbles compared to a software approach.

In some aspects, the hardware approach of the present disclosure can execute a fast, compressed clear only for the parts of the system memory associated with the specific clear-only tiles. By doing so, the hardware approach may not require a full clear of the entire surface in the system memory and/or writing a particular tile to the system memory. As such, this approach may not require the full surface to be cleared, e.g., between the binning pass and the render pass, since the GPU can perform this clear in a piecemeal fashion, e.g., based on which tiles are clear-only. One benefit to this approach can be that the clear is performed straight to the system memory fully compressed, rather than performing any work in the GPU memory. As mentioned previously, the approach can also move the conditional execution closer to the hardware, e.g., in the microcode, for fewer pipeline bubbles. In some aspects, this hardware approach can use small annotations in the software command stream to assist the hardware in identifying sections that may be skipped.

As mentioned herein, clear-only tiles in the aforementioned hardware approach can perform a fast, compressed system clear. For instance, this approach can avoid modifying or clearing data multiple times, e.g., for tiles with a visible draw call. In some aspects, rather than performing the clear up front, the hardware approach can perform the clear on a tile-by-tile basis. As such, for example, the GPU may only write to the buffer as tiles are being skipped. In some aspects, in the hardware, the present disclosure can detect there is no visible geometry in a bin, and then issue the clear from the hardware, e.g., for tiles where there is no visible geometry or geometry touching the tile. As such, the present disclosure can issue a compressed clear directly from the hardware, e.g., from the compression blocks in the hardware. Accordingly, in this approach, the present disclosure may not clear the entire surface of the tiles at the same time. In contrast, using the software approach mentioned above, the present disclosure may clear extra bits of the buffer, e.g., even if these bits do not need clearing. Although the buffer is small compared to the entire system memory, in some instances this hardware approach may save bandwidth compared to other clearance approaches.

In some aspects, during the hardware approach, the present disclosure can clear on a per tile basis, such that tiles are only cleared when necessary to do so. Based on this, the present disclosure can have the hardware track which tiles are clear-only, e.g., whether or not they have visible geometry. In some instances, the present disclosure can utilize this clear from the hardware for tiles that include a clear-only status. For example, if a tile includes a portion of an image, the present disclosure can render that image and save it to the system memory. Moreover, if a tile has no image, the present disclosure can perform a fast clear to the untouched portion of the memory, e.g., the buffer.

Compared to the aforementioned software approach, the hardware approach may modify the buffer on a tile-by-tile basis, rather than writing clear color information to the entire buffer at once. For instance, during the software approach described herein, the present disclosure can clear the buffer to the clear color value up front, such that individual bins can be skipped. In contrast, during the hardware approach described herein, the present disclosure can determine if certain bins or tiles can be skipped, as discussed above, and then modify the buffer on a tile-by-tile basis. As such, in the hardware approach, the present disclosure can inform the hardware of a small buffer clear for certain tiles. In some aspects, the hardware may not directly use the buffer, as the software may instruct the hardware regarding which functions to perform. For example, the hardware approach can include programing the hardware for a certain clear color, and for tiles that can be skipped, the clear color can be written to the corresponding buffer data or section. In some aspects, the hardware can perform the clear for the entire buffer, or the hardware can perform the clear on an individual tile basis.

As shown in FIG. 3, the present disclosure can generate, for each of tiles 304, 314, 324, 334 in a set of tiles in a tile memory, visibility information for the tile. This visibility information can include information regarding whether the tile has visible draw calls or rendering, and can be generated for each tile in a binning pass. Also, the present disclosure can render at least one tile, e.g., tile 314, to a system memory. The at least one tile, e.g., tile 314, can include additional information other than the clear color information. In addition, when rendering tile 314 to the system memory, the present disclosure can further skip certain tiles, e.g., tiles 304, 324, 334, that include only clear color information. In some aspects, the hardware can perform the compressed system memory clear for the tile. The present disclosure can also write, for each tile 304, 314, 324, 334, clear color information to a buffer section 302, 312, 322, 332 corresponding to the tile. Further, the present disclosure can write, for the at least one tile that includes the additional information, e.g., tile 314, information associated with the additional information to the buffer corresponding to the tile, e.g., buffer section 312. In some aspects, the additional information can be based on the visibility information. Additionally, the system memory can include compressed data corresponding to each tile in the tile memory, e.g., tiles 304, 314, 324, 334. The buffer can also include information associated with the compressed data, e.g., buffer sections 302, 312, 322, 332, that correspond to each tile, e.g., tiles 304, 314, 324, 334.

The aforementioned techniques can provide a number of benefits or advantages to tiled rendering GPUs. For example, the present disclosure can reduce the amount of time necessary to perform a system memory clearance. Additionally, the present disclosure can reduce the bandwidth and/or power required to clear the system memory. In some tiled rendering GPUs, the present disclosure can save time per clear-only tile, e.g., up to or exceeding 15 microseconds. In some instances, e.g., for surfaces with a large number of pixels, this may add up to hundreds of microseconds saved when processing a particular surface. As the number of clear-only tiles increases, the present disclosure can save an increased amount of time. As noted above, a surface clear can be a clearance of all the data in an image or surface.

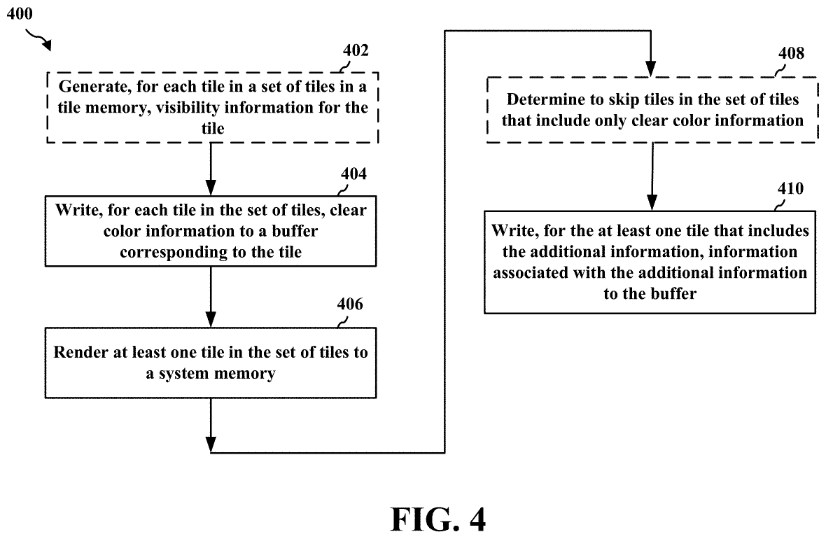

FIG. 4 illustrates an example flowchart 400 of an example method in accordance with one or more techniques of this disclosure. The method may be performed by a GPU or apparatus for graphics processing. At 402, the apparatus may generate, for each tile in a set of tiles in a tile memory, visibility information for the tile, as described in connection with the examples in FIGS. 2 and 3. In some aspects, the visibility information can include information regarding whether the tile has visible draw calls or rendering, as described in connection with the examples in FIGS. 2 and 3. At 404, the apparatus can write, for each tile in the set of tiles in the tile memory, clear color information to a buffer corresponding to the tile, as described in connection with the examples in FIGS. 2 and 3.

At 406, the apparatus can render at least one tile in the set of tiles to a system memory, as described in connection with the examples in FIGS. 2 and 3. In some aspects, the at least one tile can include additional information other than the clear color information, as described in connection with the examples in FIGS. 2 and 3. At 408, to render the at least one tile to the system memory, the apparatus can further determine to skip tiles in the set of tiles that include only clear color information, as described in connection with the examples in FIGS. 2 and 3. At 410, the apparatus can write, for the at least one tile that includes the additional information, information associated with the additional information to the buffer corresponding to the tile, as described in connection with the examples in FIGS. 2 and 3. As mentioned above, the additional information can be visibility information or shading information. In some aspects, the apparatus can be a wireless communication device.

Additionally, in some aspects, the visibility information can be generated for each tile in a binning pass, as described in connection with the examples in FIGS. 2 and 3. Moreover, the additional information can be based on the visibility information, as described in connection with the examples in FIGS. 2 and 3. In some aspects, the system memory can include compressed data corresponding to each tile in the set of tiles in the tile memory, as described in connection with the examples in FIGS. 2 and 3. Further, the buffer can include information associated with the compressed data corresponding to each tile in the set of tiles, as described in connection with the examples in FIGS. 2 and 3. The apparatus can also send, via one or more frames, the clear color information or the information associated with the additional information to a display, as described in connection with the examples in FIGS. 2 and 3.

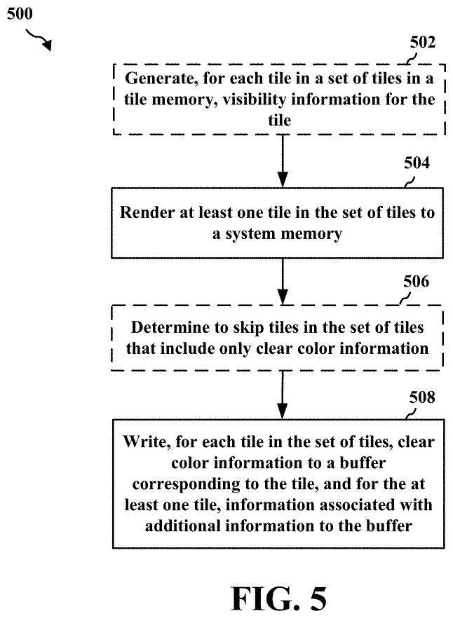

FIG. 5 illustrates an example flowchart 500 of an example method in accordance with one or more techniques of this disclosure. The method may be performed by a GPU or apparatus for graphics processing. At 502, the apparatus may generate, for each tile in a set of tiles in a tile memory, visibility information for the tile, as described in connection with the examples in FIGS. 2 and 3. The visibility information can include information regarding whether the tile has visible draw calls or rendering, as described in connection with the examples in FIGS. 2 and 3. At 504, the apparatus can render at least one tile in the set of tiles to a system memory, as described in connection with the examples in FIGS. 2 and 3. In some aspects, the at least one tile can include additional information other than the clear color information, as described in connection with the examples in FIGS. 2 and 3. At 506, to render the at least one tile to the system memory, the apparatus can further determine to skip tiles in the set of tiles that include only clear color information, as described in connection with the examples in FIGS. 2 and 3.

At 508, the apparatus can write, for each tile in the set of tiles in the tile memory, clear color information to a buffer corresponding to the tile, as described in connection with the examples in FIGS. 2 and 3. Additionally, at 508, the apparatus can write, for the at least one tile that includes the additional information, information associated with the additional information to the buffer corresponding to the tile, as described in connection with the examples in FIGS. 2 and 3. In some aspects, the apparatus can be a wireless communication device.

In some aspects, the visibility information can be generated for each tile in a binning pass, as described in connection with the examples in FIGS. 2 and 3. Further, the additional information can be based on the visibility information, as described in connection with the examples in FIGS. 2 and 3. In some instances, the system memory can include compressed data corresponding to each tile in the set of tiles in the tile memory, as described in connection with the examples in FIGS. 2 and 3. In addition, the buffer can include information associated with the compressed data corresponding to each tile in the set of tiles, as described in connection with the examples in FIGS. 2 and 3.

In one configuration, a method or apparatus for operation of a GPU is provided. The apparatus may be a GPU or some other processor in graphics processing. In one aspect, the apparatus may be the processing unit 120 within the device 104, or may be some other hardware within device 104 or another device. The apparatus may include means for writing, for each tile in a set of tiles in a tile memory, clear color information to a buffer corresponding to the tile. The apparatus may also include means for rendering at least one tile in the set of tiles to a system memory, where the at least one tile includes additional information other than the clear color information. Additionally, the apparatus may include means for writing, for the at least one tile that includes the additional information, information associated with the additional information to the buffer corresponding to the tile. The apparatus may also include means for skipping tiles in the set of tiles that include only clear color information. Further, the apparatus can include means for generating, for each tile in the set of tiles, visibility information for the tile, where the visibility information includes information regarding whether the tile has visible draw calls.

As mentioned herein, the subject matter described herein can be implemented to realize one or more benefits or advantages. For instance, the described graphics processing techniques can be used by GPUs or other graphics processors to reduce the amount of time spent to clear the system memory. This can also be accomplished at a low cost compared to other graphics processing techniques. Additionally, the graphics processing techniques herein can reduce the bandwidth and/or power required to clear the system memory. In some tiled rendering GPUs, the present disclosure can reduce the time required per clear-only tile. In some aspects, this can result in a significant amount of time saved during processing.

In accordance with this disclosure, the term “or” may be interrupted as “and/or” where context does not dictate otherwise. Additionally, while phrases such as “one or more” or “at least one” or the like may have been used for some features disclosed herein but not others; the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices,. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules or units are described in this disclosure to emphasize functional aspects of devices configured to perform the disclosed techniques, but do not necessarily require realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

What is claimed is:

1. A method of operation of a graphics processing unit (GPU), comprising:
writing, for each tile in a set of tiles in a tile memory, clear color information to a buffer corresponding to the tile;
rendering at least one tile in the set of tiles to a system memory, wherein the at least one tile includes additional information other than the clear color information; and
writing, for the at least one tile that includes the additional information, information associated with the additional information to the buffer corresponding to the tile.

2. The method of claim 1, wherein rendering the at least one tile to the system memory further comprises:
determining to skip tiles in the set of tiles that include only clear color information.

3. The method of claim 1, further comprising:
generating, for each tile in the set of tiles, visibility information for the tile, wherein the visibility information includes information regarding whether the tile includes visible draw calls.

4. The method of claim 3, wherein the visibility information is generated for each tile in a binning pass.

5. The method of claim 3, wherein the additional information is based on the visibility information.

6. The method of claim 1, wherein the system memory includes compressed data corresponding to each tile in the set of tiles in the tile memory, wherein the buffer includes information associated with the compressed data corresponding to each tile in the set of tiles.

7. The method of claim 1, further comprising:
sending, via one or more frames, the clear color information or the information associated with the additional information to a display.

8. A method of operation of a graphics processing unit (GPU), comprising:
rendering at least one tile in a set of tiles in a tile memory to a system memory, wherein the at least one tile includes additional information other than clear color information; and
writing, for each tile in the set of tiles, clear color information to a buffer corresponding to the tile, and for the at least one tile that includes the additional information, information associated with the additional information to the buffer corresponding to the tile.

9. The method of claim 8, wherein rendering the at least one tile to the system memory further comprises:
determining to skip tiles in the set of tiles that include only clear color information.

10. The method of claim 8, further comprising:
generating, for each tile in the set of tiles, visibility information for the tile, wherein the visibility information includes information regarding whether the tile includes visible draw calls.

11. The method of claim 10, wherein the visibility information is generated for each tile in a binning pass.

12. The method of claim 10, wherein the additional information is based on the visibility information.

13. The method of claim 8, wherein the system memory includes compressed data corresponding to each tile in the set of tiles in the tile memory.

14. The method of claim 13, wherein the buffer includes information associated with the compressed data corresponding to each tile in the set of tiles.

15. An apparatus for operation of a graphics processing unit (GPU), comprising:
a memory; and
at least one processor coupled to the memory and configured to:
write, for each tile in a set of tiles in a tile memory, clear color information to a buffer corresponding to the tile;
render at least one tile in the set of tiles to a system memory, wherein the at least one tile includes additional information other than the clear color information; and
write, for the at least one tile that includes the additional information, information associated with the additional information to the buffer corresponding to the tile.

16. The apparatus of claim 15, wherein to render the at least one tile to the system memory further comprises the at least one processor configured to:
determine to skip tiles in the set of tiles that include only clear color information.

17. The apparatus of claim 15, wherein the at least one processor is further configured to:
generate, for each tile in the set of tiles, visibility information for the tile, wherein the visibility information includes information regarding whether the tile includes visible draw calls.

18. The apparatus of claim 17, wherein the visibility information is generated for each tile in a binning pass, wherein the additional information is based on the visibility information.

19. The apparatus of claim 15, wherein the apparatus is a wireless communication device.

20. The apparatus of claim 15, wherein the system memory includes compressed data corresponding to each tile in the set of tiles in the tile memory, wherein the buffer includes information associated with the compressed data corresponding to each tile in the set of tiles.
